(19) United States
(12) Patent Application Publication
(10) Pub. No.: US 2016/0027033 A1
(43) Pub. Date: Jan. 28, 2016

(54) METHOD FOR MANAGING AN ELECTRONIC COUPON

(71) Applicant: kWallet GmbH, Wien (AT)

(72) Inventor: Markus LOBMAIER, Wien (AT)

(21) Appl. No.: 14/781,752

(22) PCT Filed: Jun. 19, 2012
(86) PCT No.: PCT/EP2012/061692

§ 371 Date: Oct. 1, 2015

(51) Int. Cl. G06Q 30/02; G06Q 20/32; G06Q 20/38

(52) U.S. Cl. CPC G06Q 30/0222; G06Q 20/387; G06Q 30/0238; G06Q 20/327

(57) ABSTRACT

Method for processing an electronic coupon (G1-Gn) in a device (2), in particular a mobile device, the coupon (G1-Gn) being for redemption at a terminal (3) during contactless communication between the device (2) and the terminal (3). In said method, a coupon (G1-Gn.) is received, and the available coupon (G1-Gn) is activated as user interaction is ascertained, said user interaction representing the user's (K1-Km) agreement that the coupon (G1-Gn) can be redeemed during said contactless communication with the terminal (3), and the activated coupon (G1-Gn) is transmitted from the device (2) to the terminal (3) during the contactless communication without further ascertainment of user interaction being required to verify the coupon.

### TECHNICAL FIELD

The invention relates to a method for processing an electronic coupon in a device.

The invention further relates to a device for processing an electronic coupon.

The invention further relates to a use of a device for releasing an electronic coupon.

The invention further relates to a data processing means for managing an electronic coupon.

The invention further relates to a system for processing an electronic coupon.

### BACKGROUND

Conventional coupons, for example discount coupons, are distributed to customers on behalf of a company and are for example unequivocally identified by a barcode. Coupons of this kind are intended to “tie” the customer to the company because they grant certain advantages to the customer and encourage him to buy goods. Handling such conventional coupons is often laborious. The use of electronic coupons for use in customer loyalty programs has lately been under discussion. A process for redeeming an electronic coupon has for example been disclosed in the WO 2009/151401. In here a system has been described, which comprises a mobile device and a point-of-sale terminal for redeeming an electronic coupon. The electronic coupon is stored in a secure element (SE for short) in the mobile device and can be redeemed by way of a contactless radio frequency communication, RF-communication for short, with the point-of-sale terminal. However, before the electronic coupon can be redeemed, the user must select a coupon in order to display its details on a display of the device and to perform a visual verification. Then a cumbersome reconciliation process between the customer and a sales assistant is required. It is not until the sales assistant has satisfied himself with the aid of the display on the mobile device that the electronic coupon has not yet expired, has not yet been redeemed and does not belong to another company, that the coupon can be released for redemption by the sales assistant at the point-of-sale terminal. Only then can the coupon be read from the SE by presenting it to a contactless reading device at the point-of-sale terminal as part of a contactless RF communication and be redeemed. Redemption is, however, carried out offline in the form of a printout of a coupon redemption invoice and coupon and payment transactions are not reconciled until the end of the day.

It is the requirement of the invention to propose an improved device, an improved data processing means and an improved system in order avoid the problems mentioned in the beginning.

### SUMMARY OF THE INVENTION

This requirement is met by a method according to claim 1, a device according to claim 10, a use according to claim 11, a data processing means according to claim 12, a system according to claim 14.

The subject of the invention therefore comprises a method for processing an electronic coupon in a device, in particular a mobile device, wherein the coupon is destined to be redeemed at a terminal as part of a contactless communication between the device and the terminal, the coupon being received, and the available coupon being activated by ascertaining a user interaction representing a consent by the user that the coupon can be redeemed during said contactless communication with the terminal, and the activated coupon being transmitted from the device to the terminal during the contactless communication without any further ascertainment of a user interaction being required to verify the coupon.

Further the subject of the invention comprises a device, in particular a mobile device, for processing an electronic coupon, the coupon being destined for redemption at a terminal during a contactless communication between the device and the terminal, wherein the device is configured: to receive a coupon and to activate the available coupon through ascertainment of a user interaction regarding the available coupon, which user interaction represents a consent by the user that the coupon can be redeemed during said contactless communication with the terminal, and to transmit the activated coupon from the device to the terminal during the contactless communication without further ascertainment of a user interaction being required to verify the coupon.

Further the subject of the invention comprises a use of a device, in particular a mobile device, for releasing an electronic coupon for the purpose of using it in a system comprising at least one device, one data processing means and one terminal, wherein the coupon is destined to be redeemed at a terminal during a contactless communication between the device and the terminal, wherein at the device a coupon is received, which is made available by a data processing means for redemption at the said terminal, and the coupon is activated in the terminal through ascertainment of a user interaction representing a consent by the user that the coupon can be redeemed during said contactless communication with the terminal, so that the said coupon can be transmitted during the contactless communication from the device to the terminal without further ascertainment of a user interaction being required to verify the coupon.

Further the subject of the invention comprises a data processing means for managing an electronic coupon, the coupon being destined to be redeemed at a terminal during a contactless communication between a device and the terminal, wherein the data processing means is configured for making the coupon available both for the terminal and for the device, so that a coupon activated at the device through ascertainment of a user interaction representing a consent by the user that the coupon can be redeemed during said contactless communication with the terminal can be transmitted to the terminal and immediately redeemed at it without further ascertainment of a user interaction being required to verify the coupon.

Further the subject of the invention comprises a system for processing an electronic coupon, the coupon being destined to be redeemed at a terminal as part of a contactless communication between a device and the terminal, wherein the system comprises: a data processing means according to the invention, and at least one device according to the invention, in particular a mobile device.

The device may be a mobile device, in particular a programmable mobile device such as a smartphone or a tablet computer on which an application such as the computer program product is executed, the application being downloadable from an application store via the internet. However, the device may also be a computer such as a laptop or a PC, on which a web application is executed as the computer program product. Similarly a computer or another mobile device may provide a website, for example with the aid of a web browser, which website provides the functionality of the method according to the invention. Or the device may comprise a hard-wired logic circuit which provides a method according to the invention.

An electronic coupon, also called a voucher, is represented as data. Such a coupon is, for example, issued by a commercial enterprise or service provider or by public bodies such as public authorities or agencies, called “company” for short in the following, to potential customers or members, called “customers” for short in the following, and is used, in the main, to acquire customers and build customer loyalty and in this context to purchase goods or services at advantageous conditions.

The device is configured to ascertain an interaction of a user with the device. It may, for example, comprise a touchscreen for detecting a touch, an audio processing stage for detecting language or a stage for detecting certain movements of the device.

The company can themselves issue such coupons to customers or defer this activity to an external service provider. Issuing the coupons is done in an electronic manner wherein the coupons are communicated or transferred to the device of a customer. The communication with these devices is effected via a conventional wired internet connection or via a mobile network, also called over-the-air (OTA) communication, as a primary data connection. When using a mobile network, for example based on GSM, UMTS or WLAN technology, the company or the external service provider has access to corresponding communication means and the customer's devices are equipped with respective GSM, UMTS or WLAN communication means. It is possible, in a market, for several companies to access the service of one or more such external service providers.

To redeem a coupon it is necessary for the coupon to be transmitted or made known to e.g. a point-of-sale terminal, wherein the point-of-sale terminal is associated with the company. To this end the device is brought into the communication zone of a contactless write and/or read means of the terminal. Contactless communication with the terminal may be effected based on a capacitive coupling, for instance. Preferably contactless communication is effected with the aid of a near-field communication device (NFC device), which is implemented both on the side of the device and on the side of the terminal. NFC may be standardised using, for example, ISO 14443, 18092, 21481, ECMA 340, 352, 356, 362 or ETSI TS 102 190. At this point it should also be mentioned that a terminal or a group of terminals may be associated with different companies.

The invention brings with it the advantage that the decision, as to whether a coupon should be handed over to the terminal during the next contactless communication with the terminal because of its association with the company which had issued it, lies exclusively in the hands of the user of the device. Using the device the user can indicate his decision to redeem the coupon, by a single interaction, i.e. ultimately his wish to redeem it. Not until the coupon is activated does it become available for immediate redemption during a contactless communication between the device and the terminal. During the next communication with the terminal, after activation of the coupon, the user's decision is no longer queried and the coupon is transmitted to the terminal without any further user-controlled interference or involvement of the user concerning coupon verification.

The activated state of a coupon is stored in the device. The time span between activation of the coupon and completed transmission of the activated coupon to the terminal therefore passes without further ascertainment of a user interaction for the purpose of renewed selection and/or coupon verification or checking such as checking of the coupon data by a user of the device or displaying and checking of the coupon by a terminal assistant. The coupon, once it is activated, does not, after activation, need to be selected again by means of a user interaction and displayed on a user interface of the device, as soon as it is redeemed. This measure is of particular importance especially then, when a plurality of coupons is to be used for a purchase, wherein each coupon is, for example, associated with a type of goods for which a discount is due. The coupons to be redeemed are activated ahead of redemption at the same time or at different points in time, and their activated state is stored until redemption. Redeeming a coupon is therefore considerably accelerated. The user interface, at the time of transmission or in the preceding time period up to immediately after activation of the coupon, is therefore available for activities other than coupon verification. Although in the time span following activation of the coupon up to completed transmission of the coupon to the terminal no further selection and/or coupon verification is required, which is caused by ascertaining a user interaction with the device for transmission of the coupon to the terminal, it is of advantage if the validity of the activated coupon is automatically verified or checked in the device and the activated coupon is deleted once validity has expired (e.g. at midnight on the day in question) and is thus no longer available for transmission to the terminal. An activated coupon is thus transmitted to the terminal provided its validity has been automatically verified in the device. The automatic coupon verification taking place in the device for an activated coupon is effected either with the aid of a first processing stage of the device or with the aid of an additional second processing stage of the device responsible for safety-technical aspects, for example a secure element. The invention thus permits frontend activation of coupons for selective redemption, wherein frontend is understood to mean the device, with which a coupon for global use in a system for processing the coupon can be locally activated (primed). On the side of the terminal, after receiving the coupon, a verification is carried out as to whether the coupon is indeed to be considered because the coupon has been available there with the aid of the data processing means. To this end the respective customer can initially be ascertained, which is effected automatically during contactless communication between device and terminal by transferring a customer ID from the device to the terminal. Availability of the coupon for the respective customer may be due to various conditions. As such the coupon may e.g. only be used for a certain article or service or only as from a certain quantity onwards. On the other hand, the coupon may have a temporal validity and may therefore be used during a certain period of time only.

Moreover, due to the invention an important psychological effect is created for the customer. For the first time the customer is offered the possibility, ahead of a purchase, of actively deciding which coupon he wants to redeem, since he has to activate a certain coupon for redemption according to his requirement prior to a transaction such as prior to an electronic payment process at the terminal. Thus it is ensured that exactly that coupon which the customer actually intends to redeem, is redeemed because he gains the biggest advantage by it. In this way an arbitrary, unintended or uncontrolled redemption of coupons available in the device is avoided, and moreover without a need, after activating the coupon and prior to contactless transmission of the coupon to the terminal, for the customer or sales personnel having to perform a visual check of the coupon to be redeemed.

For the customer this upstream process step of activating a coupon represents an important point because he can control in a transparent and reproducible manner how he wants the final reduced price to be made up, in particular also how he can control it by his intent of redeeming the coupon by activating it. This is also most important to the company because the marketing/customer loyalty effect to be achieved with the help of the coupon is not completed until the coupon has been activated by the upstream process of coupon activation. The added value of the customer loyalty program becomes immediately transparent to the customer. This would, for example, not be the case if the coupons transmitted to the device were immediately or always, activated for redemption.

As already mentioned the measures according to the invention bring with it the advantage that when the coupon is redeemed, there is no need for a cumbersome reconciliation process between the customer and the seller or his sales personnel at the terminal, such as a point-of-sale terminal. Rather the process of redeeming the coupon is completely hidden for the sales personnel. Sales personnel can concentrate entirely on their core task of recording the goods to be paid for and of completing the payment process. The invention thus considerably simplifies work for the sales personnel. Compared to the known processes waiting times for customers at the checkout terminal are reduced. The process of redeeming the coupon during the checkout process is unobtrusive, discrete and hardly noticeable for all concerned.

Further particularly advantageous designs and developments of the invention are revealed in the dependent claims and the description below. The device, use, data processing means, system may be further developed in accordance with the dependent claims for the process. Advantages discussed in conjunction with features of the one category or one group of claims, also apply analogously to those of the other category or other group of claims.

In such a system, apart from the data processing means of the company, the terminals of the company and the devices of the users, there may also exist a so-called Trusted Service Manager, called TSM for short. The TSM may perform electronic distribution of one or more applications to the one or more devices, wherein the application in the device provides, when executed, the functionality defined according to the method of the invention.

According to one aspect of the invention ascertainment of a user interaction may be effected by means of a user interface, which user interface is generated by executing a first software, in particular a user interface application, on a first processor of the first processing stage (first hardware environment). This measure has the advantage that user interaction is limited to the first hardware component, which allows access to a multitude of possibilities available on the operating system of the device.

With a first realisation of the invention in which application of the secure element can be waived, it is of advantage if activating the available coupon is effected by storing the respective coupon and/or its status information indicating its active status in a memory of the first processing stage. Only electronic components such as processor, memories etc. are required in this case, which primarily serve the principle function of the device.

According to one aspect of the invention a first computer program product, in particular a user interface application, may be used which can be loaded into the device which can be programmed, and which has program code sections for performing the steps of the method according to the invention associated with ascertaining the interaction with the user for the purpose of activating the coupon, when the program is executed in the device.

With this realisation of the invention discussed in the preceding paragraph, communicating the activated coupon is effected with the aid of the NFC communication means, which advantageously are operated in the peer-to-peer mode or reader-writer mode. In the peer-to-peer mode the coupon is provided in the user interface application of the device and transmitted to the terminal via the NFC communication means integrated with the device. In read-writer mode the NFC communication means of the terminal are operated in card emulation mode and those of the device in the writer mode. Analogously the device writes the coupon into the terminal acting as a card.

According to a second realisation, in which a secure element is used on the device side, it is of advantage if activating the available coupon is effected by handing over the respective coupon from a first processing stage used for interaction with a user, to a second processing stage separate from the first processing stage, and the handed-over coupon and/or its status information indicating the active status is stored in a memory of the second processing stage. In principle the handing-over of the coupon from the first processing stage to the second processing stage in the device could be carried out within a hardware environment (processor, memory, interfaces etc.) from one software unit to another software unit, wherein both software units are processed on the one-and-only hardware environment and the respective processing stage is realised during processing. According to one aspect of this realisation, however, the two processing stages comprise different hardware environments, each of which comprises its own processor for processing the software as well as memories and interfaces associated with the processor. In a preferred embodiment of the invention the one hardware environment is used for operating the device as e.g. a platform for the operating system of a device which is a mobile phone or a smartphone. By contrast, at least in the present context, the other hardware environment integrated with the device or cooperating with the device (because it is used e.g. as a SIM card or other exchangeable component in the device) is used primarily for contactless communication with the terminal and associated safety-relevant aspects.

According to a further aspect of the second realisation of the invention reception of the handed-over coupon is effected by processing a second software, in particular a cardlet, on a second processor of the second processing stage (11) which is realised as a secure element, and the handed-over coupon is stored in a secure storage area of the secure element. This measure has the advantage that the integrity of the secure element is not endangered by expensive elements of the user interaction etc., so that the functionality of the secure element can be limited to its core areas such as security in matters of contactless transaction. Java card is a variant of the Java programming language which permits Java card applets (cardlets for short), i.e. Java applets following a reduced Java standard, to be executed. In this embodiment the coupon data is added via a Java card function. Safety-relevant aspects are integrated with the cardlet itself or implemented in there. The cardlet itself thus provides e.g. the “add coupon” function, where with this function the application which accesses the second processing stage from the first processing stage, e.g. the user interface application, hands over the respective coupon to the cardlet, so that the coupon can be stored in the secure environment of the memory of the secure element, which is associated with the respective cardlet.

According to a further aspect of the invention a second computer program product, in particular a cardlet, can be used which can be loaded into the device, which is programmable, and which has program code sections, in order to execute the steps of the method according to the invention, which are associated with the handing-over of a coupon after its activation and storage of the handed-over coupon, when the program is executed on the device.

According to a further embodiment of the invention the received coupon is stored in a second processing stage separate from the first processing stage in a memory of the second processing stage, which in particular is realised as a secure element, wherein activating of the stored coupon with the aid of the first processing stage leads to status information indicating the active status of the coupon being stored in said memory of the second processing stage. The advantage of this is that the coupon, as early as during communication with the data processing means, e.g. a safe communication, can also be stored immediately in the secure memory of the secure element, where it is assigned an inactivated status. It is not until activation with the aid of the user interaction takes place, that the coupon is assigned an active status in the SE, which enables it to be redeemed immediately at a terminal. Both safety-technical aspects and user interface aspects are clearly separated also in this exemplary embodiment.

When using a secure element it has proven to be of advantage if the activated coupon is communicated with the aid of NFC communication means, which are operated in card emulation mode. Here the NFC communication means of the device take on a passive role, as would be the case with a chip card configured for contactless communication, and the NFC communication means of the terminal take on the role of a reader, which of its own volition actively reads the card, in the present case the secure element of the device, and at the same time receives the coupon.

According to a further aspect of the invention hand-over takes place through cooperation between a first interface of the first processing stage and a second interface of the second processing stage. This is done using a hardware-type connection between the two processing stages and a software-type link with an application programming interface (API). In particular a secure connection is used, in order to safeguard the integrity of the SE.

In principle a coupon is represented as data. According to one aspect of the invention the electronic coupon is represented as coupon identification data. Especially preferably the coupon identification data comprises at least one identification number for unequivocally identifying a coupon. If required additional data fields may be present such as for entering a short name for the coupon, the validity period, the amount or value of the coupon as well as the number of admissible redemptions. The variety of data makes it possible to provide or use coupon-relevant data also in offline operations. In contrast thereto, if the necessary amount of data is reduced to a minimum, this provides for efficient memory usage and ensures that the coupon is transmitted/redeemed quickly. The coupon may also, however, be represented as a link to a server, so-called reference data or link data. The actual coupon identification data, to which reference is made with the aid of reference data or link data, is then stored on a server. The safety-technical advantage of this is that e.g. the identification number of a coupon, which forms the coupon identification data, does not have to be communicated as plain text.

In all embodiments of the invention the data processing means associated with the company takes on a central role. It is configured for managing the life cycle of the coupon and for communicating the end of the life cycle of a coupon to the terminal. The life cycle of a coupon may for example be defined by the maximum possible number of redemptions or by the time span during which it is valid. Due to this measure it is always ensured in the system that the current status of the coupons in the system handed over to the most varied devices is known to all terminals, thus avoiding misuse or erroneous redemption of a coupon. By definition a coupon which has been activated with the aid of the device is immediately redeemable, provided it is valid in the system.

Now, in order to ensure that the availability of all the various coupons circulating in the system is always kept up-to-date at the terminals, it has proven to be advantageous if the terminal is configured to store the availability of a coupon locally or to query the availability of a coupon from the data processing means as soon as a coupon is received at the terminal during a contactless communication with the device.

### SHORT DESCRIPTION OF THE FIGURES

The invention will now explained once more in detail with reference to the attached figures by way of embodiments, to which however the invention is not limited. Identical components in the various figures are marked with identical reference symbols. In the drawing

FIG. 1 shows a system according to the invention in the form of a block diagram;

FIG. 2 shows a data base content of a first data base used in the system according to FIG. 1;

FIG. 3 shows a detail of a device according to the invention as per FIG. 1 in the form of a block diagram.

### DESCRIPTION OF EMBODIMENTS

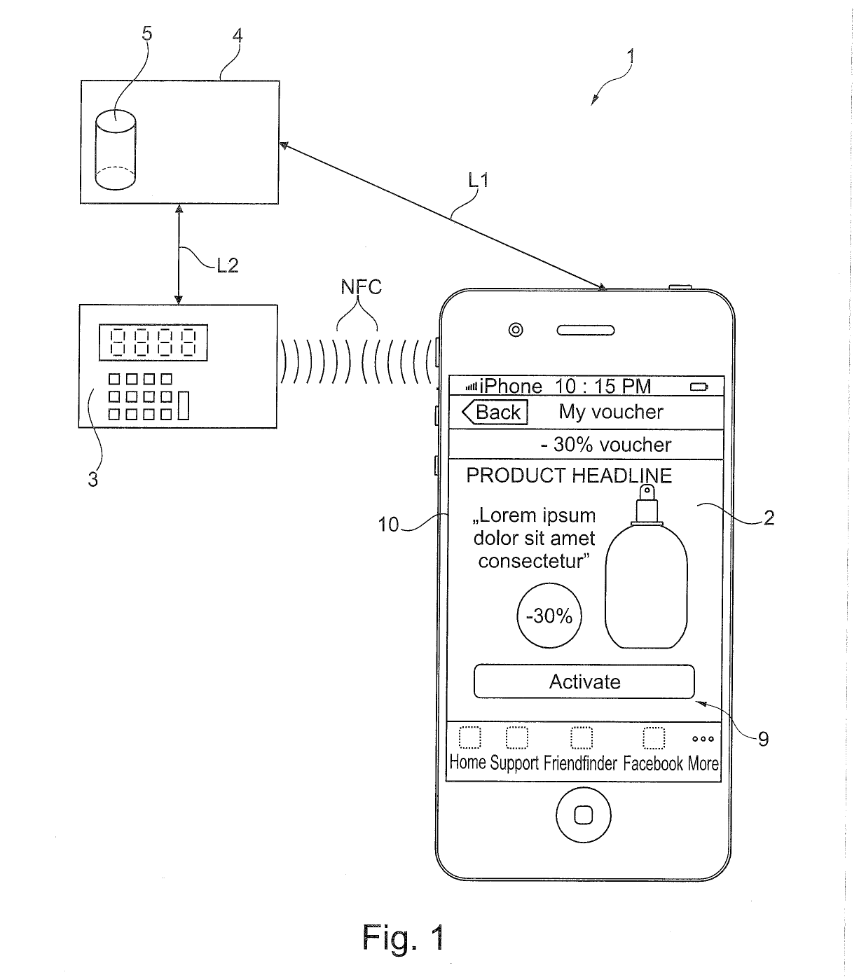

FIG. 1 shows a system 1 for managing electronic coupons G1-Gn. The system 1 comprises a mobile device 2 in the form of a smartphone and a terminal 3 for contactless NFC-based communication with said device 2, in order to redeem a coupon G1-Gn or a group of coupons G1-Gn during said NFC-based communication. The respective coupon G1-Gn is associated with the device 2 or the user (called customer Kx in the following) of the device 2. In addition the system comprises a data processing means 4 which is associated with a company managing the coupons G1-Gn, which company may, for example, be a trading company which for example markets cosmetics products. The data processing means 4 is configured to manage the electronic coupons G1-Gn. With the aid of the data processing means 4 the company acting as a coupon manager manages the life cycle of the coupons G1-Gn from the time they are issued up to their redemption or their expiry when they become invalid. The terminal 3 is also associated with the company and is, for example, located at a checkout workstation in a branch of the company. Each customer Kx is registered in a data base 5 as a regular customer and as such is a member of a customer loyalty program of the company. As part of the customer loyalty program the electronic coupons G1-Gn are distributed to customers K1 to Km. Distribution is effected via personalised applications, which are installed on the device 2 of the customer Kx.

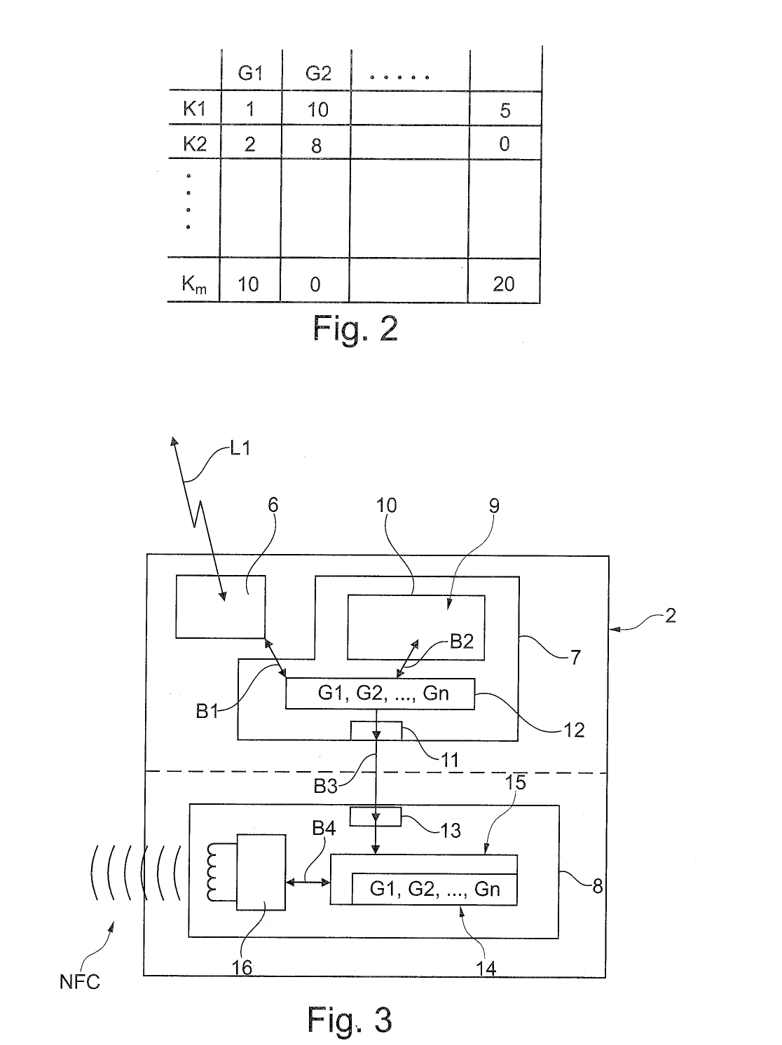

The content of the data base 5 is shown schematically in the form of a matrix in FIG. 2. This matrix shows how electronic coupons G1-Gn are associated with a customer K1 to Km and thus also with his device 2. This association is represented as association data. In addition the matrix in FIG. 2 contains numbers which indicate the number of coupons G1-Gn available to the respective customer K1-Km, or which in other words indicate, how often the respective coupon G1-Gn can be redeemed by the respective customer K1-Km. In the present case it may be assumed that the device 2 is associated with the first customer K1. A certain customer Kx may however be associated also with several devices 2. With the aid of the data processing means 4 the current number of respectively available coupons G1-Gn (see number in the matrix of FIG. 2) may also be taken into consideration. Each redemption reduces the number of respectively available coupons G1-Gn, until there are no longer any available, unless the coupon in question is a permanent coupon which may be used for a limited or an unlimited amount of time.

Each customer K1-Km is characterised by a regular customer identifier. Each coupon is characterised by a coupon identifier. A coupon identifier may exist multiple times and may be associated with a single regular customer, whereby additionally the number of possible redemptions may be stored. Similarly a coupon identifier may exist once and may be associated with different regular customer identifiers.

The data processing means 4 is configured for communication via a first data link L1 with the device 2 for communicating electronic coupons G1-Gn to the device 2. The first data link L1 used is a so-called “over-the-air” data link (OTA for short), for which a mobile network is used.

The data processing means 4 is also configured for communicating with a terminal 3 via a second data link L2. This second data link L2 is used for informing the terminal 3 of the availability, redeemability or usability of an issued coupon G1-Gn either in a push mode (communicated from the data processing means 4 actively to the terminal 3) or in a pull mode (retrieved by the data processing means from the terminal 3, e.g. in real time at the time of redeeming a coupon at the terminal 3).

In the push mode, which in this embodiment may be assumed as being the case here, terminal 3 is configured for storing a coupon locally, longer-term, until an update is received from the data processing means 4. In the pull mode terminal 3 is configured to query the availability of a coupon G1-Gn at the data processing means 4, as soon as during a contactless communication with the device 2 a coupon G1-Gn is received at the terminal 3. In this way terminal 3 is always kept informed of valid coupons G1-Gn.

Details of the device 2 shown in FIG. 1 are depicted in FIG. 3 in the form of functional units. The device 2 is configured for providing an electronic coupon G1-Gn for redemption at the terminal 3. The device 2 comprises mobile communication means 6 which are used to establish the first data link L1 with a first data processing means 4, in order to be able to receive a coupon Gk at the device 2. The device 2 comprises a first processing stage 7 for interaction with a user, of the device 2 and a second processing stage 8 for contactless communication with the terminal 3 for the purpose of redeeming said coupon G1-Gn. Data is exchanged between the communication means 6 and the operating system of the device 2 and thus made accessible to the first processing stage 7.

The first processing stage 7 is configured for ascertaining an interaction with a user, which interaction represents a consent by the user to redeem the coupon during a contactless communication with the terminal, for the purpose of activating the coupon Gk for redemption and for passing the activated coupon Gk on to the second processing stage 8. The first processing stage 7 is configured for generating a graphic user interface 9 (see also FIG. 1) with the aid of a touchscreen 10 of the device 2 for ascertaining an interaction with the user for the purpose of activating the coupon Gk. In addition a first interface 11 is utilised for passing the activated coupon Gk on to the second processing stage 8. Utilising the first interface 11 and generating the user interface 9 is realised by processing a first software on a first processor 12 of the first processing stage 7 in the environment of the operating system of the device 2.

The second processing stage 8 is configured for receiving and providing the handed-over coupon Gk, in order to redeem it during a contactless communication with the terminal 3. The second processing stage 8 is realised as a secure element and configured for utilising a second interface 13 for the purpose of receiving the activated coupon Gk from the first processing stage 7 and for the purpose of providing secure storage of the activated coupon Gk in a storage area 14 of the secure element. Reception and secure storage is realised by processing a second software, in the present case the software of a cardlet, on a second processor 15 of the secure element. The second processing stage 8 also comprises NFC communication means 16, which can be driven by the second software in order to permit contactless redemption of the activated coupon Gk at the terminal 3.

The various units 6, 7, 10, 8, 15 and 16 are connected with each other via links or bus systems B1, B2, B3 and B4.

With the system in operation, the first coupon K1 of the device 2 is issued/made available. This is communicated by the data processing means 4 via the second data link L2 to all terminals 3 (only one is shown in FIG. 1). In terminal 3 the fact is stored that a coupon G1 identified by its coupon identifier has become available to the customer K1 identified by his regular customer identifier.

In addition the coupon G1 in the form of coupon identification data is communicated, including additional data fields, via the first data link L1 to the device 2, where it is received with the aid of the mobile communication means 6 and passed on to the first processing stage 7.

After the device 2 and the terminal 3 have been informed that the coupon G1 is available, the status of the first coupon G1 in the data base 5 is changed (not shown) from “virgin” to “pending”.

The first processing stage 7 visualises the existence of the coupon G1 with the aid of the touchscreen 10 and offers an activation field with the text “activate” (see FIG. 1) for interaction with the customer K1. The customer K1, by touching the activation field, decides that the coupon G1 has to be activated, whereupon the coupon G1, in the form of coupon identification data, is handed over by the first processing stage 7 to the second processing stage 8. The coupon G1 handed over to the second processing stage 8 is taken over by the cardlet and stored in the secure storage zone 14 assigned to it.

A deactivation field now appears in place of the activation field on the touchscreen 10 showing the text “deactivate”, in order to delete the redeemability of the coupon G1 during the next contactless transaction with the terminal 3 from the second processing stage 8 by deactivating the coupon G1. In the present case, however, let it be assumed that the customer K1 does not perform this deactivation.

At this point it should be mentioned that several cardlets, for example from various companies, may have been installed in a secure element. Associating companies with cardlets is accomplished via the application ID. The respective coupon of a company is stored directly in the cardlet of this company or in the secure storage area assigned to it. In the secure element only the respective cardlet has access to the coupons Gx stored in it.

At a later stage the customer K1 uses his device 2 during the purchase of products, for which he can use the coupon G1 to obtain a discount in a branch of the company which has issued the coupon G1. At a terminal 3 of a checkout he holds the device 2 into the communication area of the NFC communication means installed there so that a contactless NFC-based communication is established. The terminal 3 selects the respective cardlet via the application ID and on this cardlet calls up functions such as “getCustomerNumber” so that the regular customer identifier assigned to the customer K1 is communicated to the terminal 3, and “getcoupons” so that the coupon identifier assigned to the coupon G1 is communicated to the terminal 3. In the terminal a check is carried out as to whether a coupon is available for the customer K1 identified by his regular customer identifier, which in the present case is the case due to the coupon G1, and the corresponding discount is applied to the list price of the product.

On the device side the cardlet communicates the redemption of the coupon G1 to the first processing stage 7, where upon a renewed call-up of the user interface 9 by the customer K1 the display indicates that the coupon G1 has been redeemed and is no longer available.

On the side of terminal 3 redemption of the respective coupon G1 is communicated to the data processing means 4, where this fact and further details relating to the sales regarding customer K1 are stored for subsequent use. Here the data base content of the data base 5 is adapted, or, in other words, redemption of the coupon G1 is recorded. At the same time the status of the first coupon G1 is changed from “pending” to “used” (not shown), the left upper data field of the matrix shown in FIG. 1 is set to the value (0), which indicates that the coupon G1 is no longer available to the customer K1. At a later stage this fact and further information relating to the previously completed transaction may also be communicated to the device 2, permitting e.g. an indication on the touchscreen 10 that the coupon G1 has been consumed and that redemption of the coupon G1 has resulted in a price advantage of e.g. EUR 8.99.

According to a further embodiment of the invention the coupon Gx received at the device 2 from the data processing means 4 may be directly transferred to the secure element, i.e. the second processing stage 8 and be received and stored there by the cardlet associated with the respective company. In this embodiment also activation of the coupon is effected by the first processing stage 7, which in deviation from the previous embodiment leads to a change in the status information in the secure element, to the effect that status information indicating the active status of the coupon G1 is stored in said storage location of the respective cardlet in the secure element.

According to a further embodiment of the invention use of the secure element may be waived. In this case there is only the first processing stage, and activation of the available coupon Gx is effected by storing the respective coupon and/or by storing its status information indicating the active status, in a memory of the first processing stage. In the present case the NFC communication means 16 and the first processing stage 7 cooperate directly with each other in order to communicate the coupon Gx to the terminal 3.

According to a further embodiment of the invention the data processing means and the device may be integrated with each other to form one piece, e.g. a portable computer.

In conclusion it is pointed out once more that the embodiments which have been discussed above in detail are examples which may be modified by the expert in various ways without deviating from the scope of the invention. For completeness' sake it is also pointed out that the use of the indefinite article “a” or “an” does not mean that the respective feature cannot be present more than once. Further individually disclosed features may be combined with other features and the proportions of the illustrated features may vary without deviating from the concept of the invention.

1. A method for processing an electronic coupon (G1-Gn) in a device (2), in particular a mobile device, wherein the coupon (G1-Gn) is destined to be redeemed at a terminal (3) during a contactless communication between the device (2) and the terminal (3), wherein
a coupon (G1-Gn) is received, and
the available coupon (G1-Gn) is activated through ascertainment of a user interaction representing the consent of the user (K1-Km) that the coupon (G1-Gn) can be redeemed during said contactless communication with the terminal (3), and
the activated coupon (G1-Gn) is transmitted from the device (2) to the terminal (3) during contactless communication without any further ascertainment of user interaction being required for the purpose of coupon verification.

2. The method according to claim 1, wherein ascertainment of a user interaction is effected with the aid of a user interface (9), which user interface (9) is generated by processing a first software on a first processor (12) of the first processing stage (7).

3. The method according to claim 2, wherein activation of the available coupon (G1-Gn) is effected by storing the respective coupon (G1-Gn) and/or its status information indicating the active status in a memory of the first processing stage (7).

4. The method according to claim 3, wherein communicating the activated coupon (G1-Gn) is effected with the aid of NFC communication means (16) which are operated in peer-to-peer mode or reader-writer mode.

5. The method according to claim 1, wherein activation of the available coupon (G1-Gn) is effected by handing the respective coupon (G1-Gn) over from a first processing stage (7) used for interaction with a user (K1-Km) to a second processing stage (8) separate from the first processing stage (7) and the handed-over coupon (G1-Gn) and/or its status information indicating the active status is stored in a memory of the second processing stage (8).

6. The method according to claim 5, wherein reception of the handed-over coupon (G1-Gn) during the second processing stage (8) is effected by processing a second software, in particular a cardlet, on a second processor (15) of the second processing stage (8) realised as a secure element and the handed-over coupon (G1-Gn) is stored in a secure storage area (14) of the secure element.

7. The method according to claim 1, wherein the received coupon (G1-Gn) is stored in a second processing stage (8) separate from the first processing stage (7) in a storage area (14) of the second processing stage (8) realised in particular as a secure element, and wherein activation of the stored coupon (G1-Gn) with the aid of the first processing stage (7) leads to storing a status information indicating the active status of the coupon in said storage location (14) of the second processing stage (8).

8. The method according to claim 5, wherein communicating the activated coupon (G1-Gn) is effected with the aid of NFC communication means (16) which are operated in card emulation mode.

9. The method according to claim 1, wherein the electronic coupon (G1-Gn) is represented by coupon identification data and, if required, additional data fields.

10. A device (2), in particular a mobile device, wherein the coupon (G1-Gn) is destined to be redeemed at a terminal (3) during a contactless communication between the device (2) and the terminal (3), wherein the device (2) is configured:
to receive a coupon (G1-Gn), and
to activate the available coupon (G1-Gn) through ascertainment of a user interaction with regard to the available coupon (G1-Gn), which user interaction represents a consent of the user (K1-Km) to allow the coupon (G1-Gn) to be redeemed during said contactless communication with the terminal (3), and
to transmit the activated coupon (G1-Gn) from the device (2) to the terminal (3) during the contact communication without any further ascertainment of a user interaction for the purpose of coupon verification.

11. A use of a device (2), in particular a mobile device, for releasing an electronic coupon (G1-Gn) for use in a system comprising at least one device (2), one data processing means (4) and one terminal (3), wherein the coupon (G1-Gn) is destined to be redeemed at a terminal (3) during a contactless communication between the device (2) and the terminal (3), wherein
at the device (2) a coupon (G1-Gn) is received which is made available by a data processing means (4) for redemption at said terminal (3) and the coupon (G1-Gn) is activated in the device (2) through ascertainment of a user interaction which represents a consent by the user (K1-Km) to allow the coupon (G1-Gn) to be redeemed during said contactless communication with the terminal (3), thereby allowing said coupon (G1-Gn) to be transmitted from the device (2) to the terminal (3) during the contactless communication without any further ascertainment of a user interaction being required for the purpose of coupon verification.

12. A data processing means (4) for managing an electronic coupon (G1-Gn), wherein the coupon (G1-Gn) is destined to be redeemed at a terminal (3) during a contactless communication between a device (2) and a terminal (3), wherein the data processing means (4) is configured to make the coupon (G1-Gn) available both for the terminal (3) and for the device (2) so that a coupon (G1-Gn) activated at the device (2) through ascertainment of a user interaction representing a consent of the user (K1-Km) to allow the coupon (G1-Gn) to be redeemed during said contactless communication with the terminal (3) can be transmitted from the device (2) to the terminal (3) during the contactless communication without any further ascertainment of a user interaction being required for the purpose of coupon verification and immediately redeemed at the terminal (3).

13. The data processing means (4) according to claim 12, which is configured for managing the life cycle of a coupon (G1-Gn) and for communicating the end of the life cycle to the terminal (3) and/or the device (2).

14. A system (1) for processing an electronic coupon (G1-Gn), wherein the coupon (G1-Gn) is destined to be redeemed at a terminal (3) as part of a contactless communication between a device (2) and the terminal (3), wherein the system (1) comprises:
a data processing means (4) according to claim 12, and
at least one device (2), in particular a mobile device according to claim 10.

15. The system (1) according to claim 13, wherein the system (1) comprises at least one terminal (3) for contactless communication with the device (2), and wherein the terminal (3) is configured to immediately redeem a coupon (G1-Gn) received during a contactless communication with the device (2), when the received coupon (G1-Gn) has been made available by the data processing means (4).

16. The system (1) according to claim 13, wherein the terminal (3) is configured
to locally store the availability of the coupon (G1-Gn) or
to query the availability of a coupon (G1-Gn) at the data processing means (4) as soon as a coupon (G1-Gn) is received at the terminal (3) during a contactless communication with the device (2).
